(19) United States
(12) Patent Application Publication
(10) Pub. No.: US 2026/0241586 A1
(43) Pub. Date: Aug. 20, 2026

(54) Box Cutter Device

(71) Applicant: Matthew Jackson, Park Ridge, IL (US)

(72) Inventor: Matthew Jackson, Park Ridge, IL (US)

(21) Appl. No.: 19/058,982

(22) Filed: Feb. 20, 2025

(51) Int. Cl. B26B 1/08; B26B 11/00

(52) U.S. Cl. CPC B26B 1/08; B26B 11/00

(57) ABSTRACT

A box cutter device for cutting and marking an object includes a blade positioned within a housing. Rotation of the blade is designed to facilitate a user in cutting an object. The blade is selectively positionable in a stored position and an exposed position. An axle coupled to the blade is movably positioned within the housing to move the blade between the stored position and the exposed position. A handle is coupled to the housing to facilitate the user in manipulating the blade to cut the object while the blade is in the exposed position. A writing member is coupled the handle to facilitate the user in marking the object. An actuator is coupled to the handle to facilitate the user in moving the blade between the stored position and the exposed position while the user is holding the handle.

### (b) CROSS-REFERENCE TO RELATED APPLICATIONS

Not Applicable.

### (c) STATEMENT REGARDING FEDERALLY SPONSORED RESEARCH OR DEVELOPMENT

Not Applicable.

### (d) THE NAMES OF THE PARTIES TO A JOINT RESEARCH AGREEMENT

Not Applicable.

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable.

### (f) STATEMENT REGARDING PRIOR DISCLOSURES BY THE INVENTOR OR JOINT INVENTOR

Not Applicable.

### (g) BACKGROUND OF THE INVENTION

### (1) Field of the Invention

The disclosure relates to knives and more particularly pertains to a new knife for cutting and marking an object.

### (2) Description of Related Art including information disclosed under 37 CFR 1.97 and 1.98.

The prior art relates to knives. Knives come in many forms. For example, the prior art discloses small, hand-held knives that are specifically designed to facilitate users in opening packages, such as boxes. Such knives are often called box cutters. Box cutters typically include a handle that is used to manipulate the blade, and the blade is often retractable into the handle for storage. Retraction of the blade into the handle also helps to prevent injury to the user. However, once the box, or other object, is opened, the user needs to use a separate writing instrument to mark the box and identify the goods within. This is a particular problem in warehouses, factories, and restaurants where employees are constantly opening and marking boxes to refill and organize their supplies and inventory. Therefore, there is a need in the art for a box cutter that also includes a writing instrument for marking the boxes once they are opened. Ideally, such a device would have an automatically retractable blade to inhibit injury to the user.

### (h) BRIEF SUMMARY OF THE INVENTION

An embodiment of the disclosure meets the needs presented above by generally comprising a housing. A blade is positioned within the housing. The blade is rotatably coupled to the housing wherein rotation of the blade is designed to facilitate a user in cutting an object. The blade is movably coupled to the housing wherein the blade is selectively positionable in a stored position and an exposed position. An axle is coupled to the blade wherein the blade is rotatable about the axle. The axle is movably positioned within the housing wherein movement of the axle moves the blade between the stored position and the exposed position. A handle is coupled to the housing. The handle is elongated wherein the handle is designed to facilitate the user in manipulating the blade to cut the object while the blade is in the exposed position. A writing member is coupled the handle wherein the writing member is designed to facilitate the user in marking the object. An actuator movably couples the blade to the housing. The actuator is coupled to the handle wherein the actuator is designed to be accessible to the user while the user is holding the handle whereby the actuator is designed to facilitate the user in moving the blade between the stored position and the exposed position while the user is holding the handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a box cutter device according to an embodiment of the disclosure.

FIG. 2 is a rear view of an embodiment of the disclosure.

FIG. 3 is a top view of an embodiment of the disclosure.

FIG. 4 is a bottom view of an embodiment of the disclosure.

FIG. 5 is a cross-sectional view of an embodiment of the disclosure.

FIG. 6 is a cross-sectional view of an embodiment of the disclosure.

FIG. 7 is an in-use view of an embodiment of the disclosure.

### (j) DETAILED DESCRIPTION OF THE INVENTION

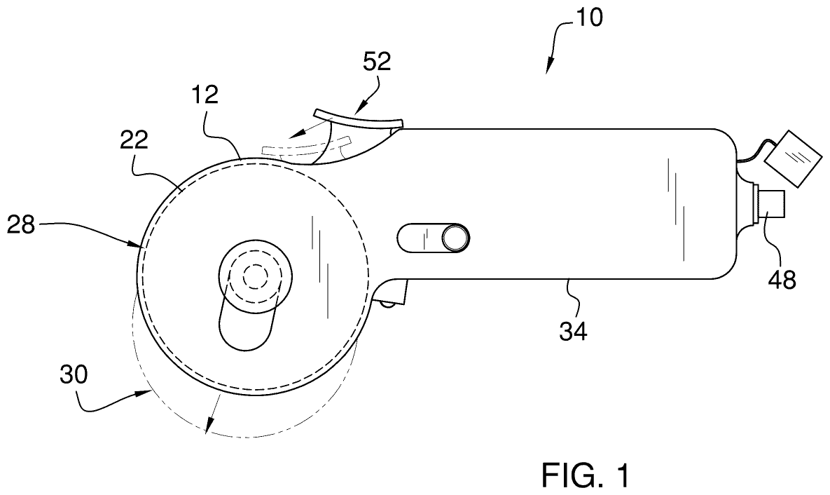

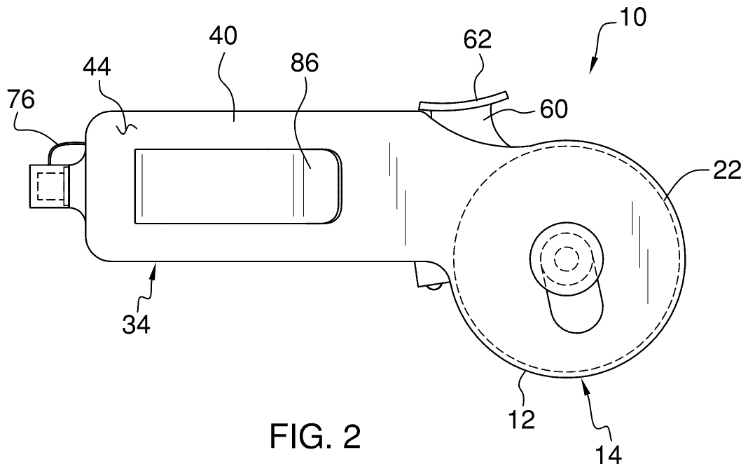

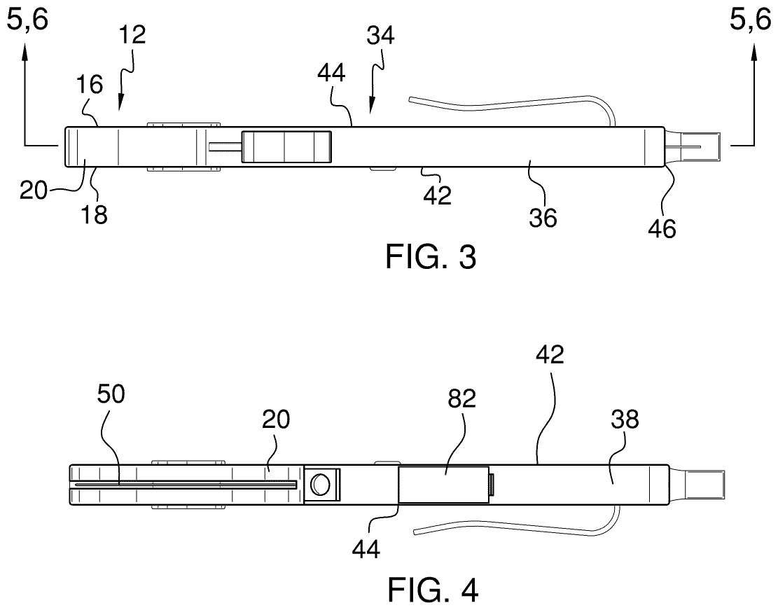

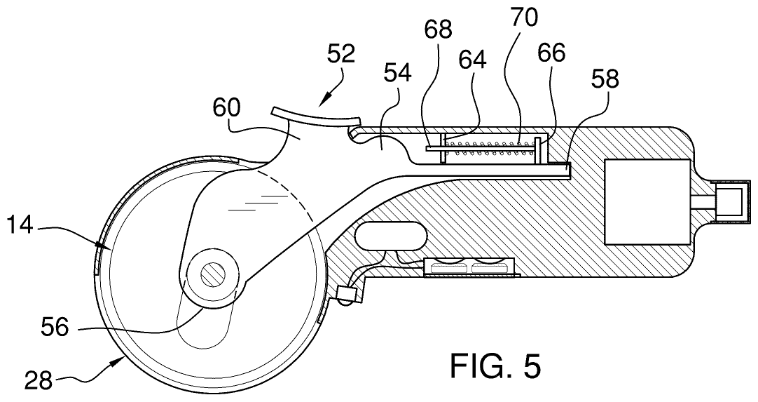

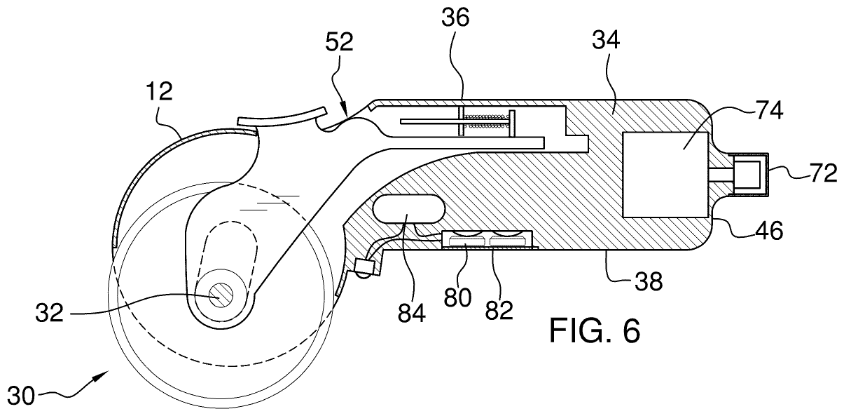

With reference now to the drawings, and in particular to FIGS. 1 through 7 thereof, a new knife embodying the principles and concepts of an embodiment of the disclosure and generally designated by the reference numeral 10 will be described.

As best illustrated in FIGS. 1 through 7, the box cutter device 10 generally comprises a housing 12. The housing 12 typically has an interior space 14. As shown in the drawings, the housing 12 may have a front wall 16, a rear wall 18, and a peripheral wall 20 that is coupled to and extends between the front wall 16 and the rear wall 18 to define the interior space 14. The front wall 16 and the rear wall 18 may be circular. In such preferred embodiments, the front wall 16 may have a diameter that is equal to a diameter of the rear wall 18. More generally, the front wall 16 may have a size that is equal to a size of the rear wall 18, even when the front wall 16 and the rear wall 18 are not circular.

A blade 22 is positioned within the housing 12. More specifically, the blade 22 is typically positioned within the interior space 14 of the housing 12. The blade 22 is rotatably coupled to the housing 12 wherein rotation of the blade 22 is configured to facilitate a user 24 in cutting an object 26. Preferred examples of the object 26 include packing tape, cardboard boxes, paper, and other packing materials. However, other alternatives of the object 26 are also contemplate 64d.

The blade 22 is also movably coupled to the housing 12 wherein the blade 22 is selectively positionable in a stored position 28 and an exposed position 30. The blade 22 may be circular, which is particularly preferred when the front wall 16 and the rear wall 18 are each circular. The blade 22 has a diameter is less than a diameter of the front wall 16 of the housing 12 wherein the blade 22 is fully covered by the housing 12 when the blade 22 is in the stored position 28. More generally speaking, the blade 22 has a size that is less than a size of the front wall 16 and the rear wall 18 of the housing 12 to ensure that the blade 22 is fully covered when the blade is in the stored position 28. The blade 22 is exposed between the front wall 16 and the rear wall 18 of the housing 12 when the blade 22 is in the exposed position 30.

An axle 32 is coupled to blade 22 wherein the blade 22 is rotatable about the axle 32. The axle 32 generally extends between the front wall 16 and the rear wall 18 of the housing 12 wherein the blade 22 is rotatable along an axis that is perpendicular to the front wall 16 and the rear wall 18 of the housing 12. The axle 32 is movably positioned within the housing 12 wherein movement of the axle 32 moves the blade 22 between the stored position 28 and the exposed position 30.

A handle 34 is coupled to the housing 12. The handle 34 is elongated wherein the handle 34 is configured to facilitate the user 24 in manipulating the blade 22 to cut the object 26 while the blade 22 is in the exposed position 30. For example, the handle 34 generally extends outwardly from the peripheral wall 20 of the housing 12 wherein the handle 34 facilitates rotation of the blade 22 along the axis that is perpendicular to the front wall 16 and the rear wall 18 of the housing 12.

The handle 34 may include a top side 36, a bottom side 38, and a lateral side 40 that is coupled to and extends between the top side 36 and the bottom side 38. The lateral side 40 may have a forward surface 42, a rearward surface 44, and a terminal surface 46. The terminal surface 46 is distally positioned on the handle 34 relative to the housing 12.

A writing member 48 is coupled to the handle 34 wherein the writing member 48 is configured to facilitate the user 24 in marking the object 26. The writing member 48 is distally positioned on the handle 34 relative to the housing 12. For example, the writing member 48 is preferably positioned on the terminal surface 46 of the lateral side 40 of the handle 34. The writing member 48 may be selected from a group consisting of a marker, a highlight 78er, a pen, and a pencil.

An actuator 52 movably couples the blade 22 to the housing 12. More specifically, the actuator 52 can be manipulated to extend the blade 22 outwardly from the housing 12 into the exposed position 30. The actuator 52 is also configured to automatically retract the blade 22 into the stored position 28 when the user 24 is not manipulating the actuator 52. The actuator 52 is coupled to the handle 34 wherein the actuator 52 is configured to be accessible to the user 24 while the user 24 is holding the handle 34. Therefore, the actuator 52 is configured to facilitate the user 24 in moving the blade 22 between the stored position 28 and the exposed position 30 while the user 24 is holding the handle 34.

The actuator 52 is generally spaced from the writing member 48 wherein the blade 22 is configured to be in the stored position 28 while the user 24 is marking the object 26 with the writing member 48. This relative positioning is configured to inhibit the blade 22 from injuring the user 24 while the user 24 is marking the object 26 with the writing member 48. Additionally, the actuator 52 is configured to inhibit the user 24 from mistakenly marking the object 26 with the writing member 48 while the user 24 is moving the blade 22 between the stored position 28 and the exposed position 30.

The actuator 52 generally includes a panel 54 that movably couples the axle 32 to the handle 34. Upward movement of the panel 54 urges the blade 22 into the stored position 28 within the interior space 14 of the housing 12. Downward movement of the panel 54 urges the blade 22 outwardly from the housing 12 into the exposed position 30.

The panel 54 may have a housing end 56 and a handle end 58. The housing end 56 is generally positioned within the interior space 14 of the housing 12. The axle 32 extends through the panel 54 proximate to the housing end 56. The handle end 58 is generally positioned within the handle 34. For example, the handle end 58 may be positioned proximate to the top side 36 of the handle 34.

A tab 60 is coupled to and extends from the panel 54. Pressure on the tab 60 moves the panel 54 downwardly through the housing 12 to urge the blade 22 into the exposed position 30. The panel 54 moves upwardly through the housing 12 to retract the blade 22 into the stored position 28 when pressure is removed from the tab 60. Therefore, the tab 60 generally extends upwardly from the panel 54.

For example, the tab 60 may have an upper surface 62 that is exposed above the top side 36 of the handle 34. The upper surface 62 may be concavely arcuate wherein the upper surface 62 is configured to facilitate the user 24 in exerting pressure on the tab 60 with a thumb of the user 24 while the user 24 is holding the handle 34 with a hand on which the thumb is positioned.

When pressure is applied to the tab 60, the tab 60 may move downwardly and outwardly relative to the handle 34. For example, the tab 60 may be positioned adjacent to the handle 34 while the blade 22 is in the stored position 28. The tab 60 may accordingly be positioned adjacent to the housing 12 while the blade 22 is in the exposed position 30. By requiring both downward and outward pressure on the tab 60 to extend the blade 22, the actuator 52 is configured to inhibit the blade 22 from being moved into the exposed position 30 until the user 24 manipulates the tab 60. For example, the downward and outward pressure is configured to inhibit the blade 22 from being accidentally moved into the exposed position 30 when the box cutter device 10 is dropped, or when another item is dropped on top of the box cutter device 10, such that only downward pressure is applied to the tab 60.

A plate 64 may be coupled to and extend downwardly from the top side 36 of the handle 34 toward the panel 54. An arm 66 may be coupled to and extend upwardly from the panel 54 toward the top side 36 of the handle 34. The arm 66 may be positioned proximate to the handle end 58 of the panel 54 wherein the arm 66 is spaced from the plate 64 and wherein the plate 64 is positioned between the arm 66 and the tab 60. Typically, the arm 66 is statically coupled to the panel 54.

A beam 68 may be coupled to the arm 66. The beam 68 extends between the arm 66 and the plate 64. For example, the beam 68 may be statically coupled to the arm 66 and movably coupled to the plate 64. Downward movement of the panel 54 slides the beam 68 through the plate 64 to move the arm 66 toward the plate 64. Upward movement of the panel 54 slides the beam 68 in the opposite direction through the plate 64, moving the arm 66 away from the plate 64.

A spring 70 may be coupled to the beam 68. The spring 70 may be compressed when the arm 66 is moved toward the plate 64. Accordingly, the spring 70 may be biased to expand wherein the spring 70 urges the arm 66 away from the plate 64 when pressure is removed from the tab 60. In such embodiments, the spring 70 pushes the beam 68 through the plate 64 to move the arm 66 away from the plate 64 and urge the panel 54 upwardly to move the blade 22 into the stored position 28 when pressure is removed from the tab 60.

A slot 50 may extend through the peripheral wall 20 of the housing 12 into the interior space 14. The slot 50 has a width exceeding a width of the blade 22 wherein the blade 22 moves through slot 50 when the blade 22 is moved between the stored position 28 and the exposed position 30. The slot 50 may be positioned proximate to the bottom side 38 of the handle 34 wherein the blade 22 extends downwardly through the slot 50 relative to the handle 34 when the blade 22 is moved into the exposed position 30. Accordingly, the slot 50 is configured to facilitate the blade 22 in being positioned downwardly away from the user 24 when the blade 22 is in the exposed position 30.

Typically, the axle 32 is spaced from the slot 50 by a first distance when the blade 22 is in the stored position 28. The axle 32 may be spaced from the slot 50 by a second distance when the blade 22 is in the exposed position 30. The first distance generally exceeds the second distance.

A cap 72 may be removably couplable to the writing member 48. Typically, the cap 72 fully covers the writing member 48 while the cap 72 is coupled to the writing member 48. The writing member 48 may be fully exposed when the cap 72 is decoupled from the writing member 48.

A tether 76 may couple the cap 72 to the handle 34. The tether 76 inhibits loss of the cap 72 while the cap 72 is decoupled from the housing 12. For example, the tether 76 may extend from the terminal surface 46 of the lateral side 40 of the handle 34.

A well 74 may be fluidly coupled to the writing member 48. The well 74 is configured to store a fluid that is expelled by the writing member 48 to mark the object 26. For example, the fluid may be ink or highlight 78er fluid, depending on whether the writing member 48 is a pen, a marker, or a highlight 78er. The well 74 is generally positioned within the handle 34 proximate to the terminal surface 46 of the lateral side 40 of the handle 34 such that the well 74 is positioned proximate to the writing member 48.

A light 78 may be coupled to the handle 34. The light 78 is configured to be actuatable to facilitate visibility of the object 26. For example, the light 78 may be positioned on the bottom side 38 of the handle 34 wherein the light 78 is configured to face toward the object 26 while the user 24 is cutting the object 26 with the blade 22.

A power source 80 is electrically coupled to the light 78. Generally, the power source 80 is positioned within the handle 34. The power source 80 may be a battery. In such embodiments, an access door 82 may be coupled to the handle 34 wherein the access door 82 is openable to expose the power source 80. For example, the access door 82 may be pivotably coupled to the handle 34. In another example, the access door 82 may be slidably coupled to the handle 34. The access door 82 may be positioned on the bottom side 38 of the handle 34.

A control 84 may be electrically coupled to the power source 80. The control 84 is actuatable to selectively actuate the light 78. The control 84 may be positioned on the forward surface 42 of the lateral side 40 of the handle 34. More generally, positioning of the control 84 is configured to facilitate the user 24 in actuating the light 78 while the user 24 is holding the handle 34. The control 84 is generally positioned proximate to the housing 12 such that the user 24 can manipulate the control 84 while the user 24 is cutting the object 26 with the blade 22.

A clip 86 may be coupled to the handle 34. The clip 86 is generally configured to releasably engage an item to facilitate the user 24 in storing the handle 34 on the item. For example, the item may be an article of clothing, a tool belt, or another item on which the handle 34 is being stored. The clip 86 may be positioned on the rearward surface 44 of the lateral side 40 of the handle 34. The clip 86 may be elongated, and the clip 86 may be parallel to the handle 34.

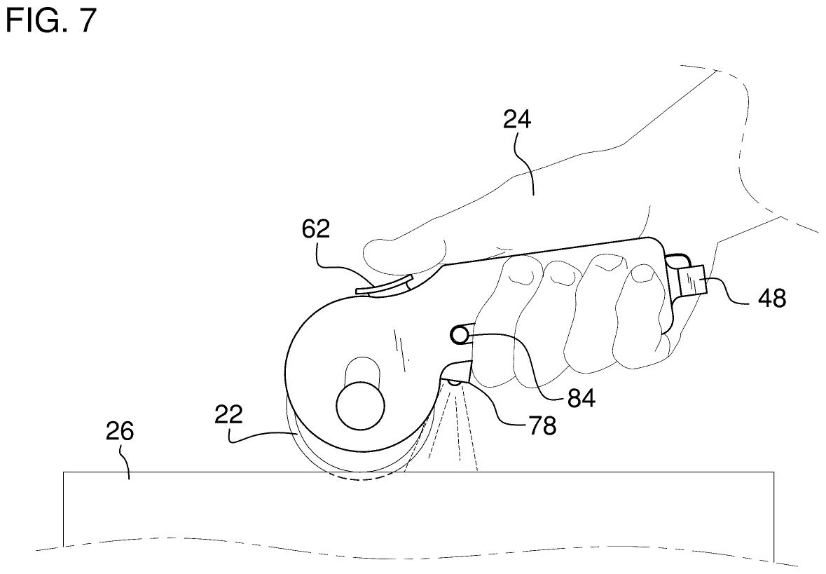

In use, the user 24 can push the tab 60 of the actuator 52 to slide the blade 22 through the slot 50 into the exposed position 30 beneath the housing 12. As shown in FIG. 7, the user 24 can then cut the object 26 using the blade 22. The light 78 can be actuated with the control 84, facilitating visibility of the object 26 while the object 26 is being cut. When the user 24 releases the tab 60, the spring 70 of the actuator 52 will expand, pulling the arm 66 away from the plate 64 and urging the panel 54 upwardly to pull the blade 22 into the interior space 14 of the housing 12. As stated above, the blade 22 generally has a size that is smaller than a size of the front wall 16 and the rear wall 18 of the housing 12 such that the blade 22 is fully covered by the housing 12 when the blade 22 is in the stored position 28.

The user 24 can mark the object 26 using the writing member 48. For example, the writing member 48 may be configured to facilitate the user 24 in identifying the contents of the object 26. For example, if the object 26 is a box that contains hamburger buns, the user 24 can mark the box with the words “hamburger buns.” Because the writing member 48 is attached to the handle 34, the user 24 does not need to use two separate tools to open and mark the object 26. Instead, the user 24 can accomplish both tasks using only the box cutter device 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A box opener assembly comprising:
a housing;
a blade being positioned within the housing, the blade being rotatably coupled to the housing wherein rotation of the blade is configured to facilitate a user in cutting an object, the blade being movably coupled to the housing wherein the blade is selectively positionable in a stored position and an exposed position;
an axle being coupled to the blade wherein the blade is rotatable about the axle, the axle being movably positioned within the housing wherein movement of the axle moves the blade between the stored position and the exposed position;
a handle being coupled to the housing, the handle being elongated wherein the handle is configured to facilitate the user in manipulating the blade to cut the object while the blade is in the exposed position;
a writing member being coupled the handle wherein the writing member is configured to facilitate the user in marking the object; and
an actuator movably coupling the blade to the housing, the actuator being coupled to the handle wherein the actuator is configured to be accessible to the user while the user is holding the handle whereby the actuator is configured to facilitate the user in moving the blade between the stored position and the exposed position while the user is holding the handle, the actuator including:
a panel movably coupling the axle to the handle wherein upward movement of the panel urges the blade into the stored position and wherein downward movement of the panel urges the blade into the exposed position; and
a tab being coupled to and extending from the panel wherein pressure on the tab moves the panel downwardly through the housing to urge the blade into the exposed position and wherein the panel moves upwardly through the housing to retract the blade into the stored position when pressure is removed from the tab.

2. The box opener assembly of claim 1, the tab further comprising an upper surface being exposed above the handle, the upper surface being concavely arcuate wherein the upper surface is configured to facilitate the user in exerting pressure on the tab.

3. The box opener assembly of claim 1, the actuator further comprising
a plate being coupled to and extending downwardly from the handle toward the panel;
an arm being coupled to and extending upwardly from the panel toward the handle, the arm being spaced from the plate, the arm being statically coupled to the panel;
a beam being coupled to the arm, the beam extending between the arm and the plate, the beam being statically coupled to the arm and movably coupled to the plate wherein downward movement of the panel slides the beam through the plate to move the arm toward the plate; and
a spring being coupled to the beam, the spring being compressed when the arm is moved toward the plate, the spring being biased to expand wherein the spring urges the arm away from the plate when pressure is removed from the tab whereby the spring urges the panel upwardly to move the blade into the stored position when pressure is removed from the tab.

4. The box opener assembly of claim 1, further comprising a cap being removably couplable to the writing member wherein the cap fully covers the writing member while the cap is coupled to the writing member.

5. The box opener assembly of claim 4, wherein the writing member is fully exposed when the cap is decoupled from the writing member.

6. The box opener assembly of claim 5, further comprising a tether coupling the cap to the handle wherein the tether wherein the tether inhibits loss of the cap while the cap is decoupled from the housing.

7. The box opener assembly of claim 1, further comprising a light being coupled to the handle wherein the light is configured to be actuatable to facilitate visibility of the object.

8. The box opener assembly of claim 7, wherein the light is positioned on a bottom side of the handle wherein the light is configured to face toward the object while the user is cutting the object with the blade.

9. The box opener assembly of claim 7, further comprising a power source being electrically coupled to the light.

10. The box opener assembly of claim 9, further comprising a control being electrically coupled to the power source wherein the control is actuatable to selectively actuate the light, the control being positioned on the handle.

11. The box opener assembly of claim 1, further comprising a clip being coupled to the handle wherein the clip is configured to releasably engage an item to facilitate the user in storing the handle on the item.

12. The box opener assembly of claim 1, the writing member being selected from a group consisting of a marker, a highlighter, a pen, and a pencil.

13. The box opener assembly of claim 1, wherein the blade is circular.

14. The box opener assembly of claim 1, the housing further comprising a front wall, a rear wall, and a peripheral wall being coupled to and extending between the front wall and the rear wall, the blade having a diameter being less than a diameter of the front wall and the rear wall wherein the blade is fully covered when the blade is in the stored position.

15. The box opener assembly of claim 14, wherein the axle extends between the front wall and the rear wall of the housing wherein the blade is rotatable along an axis being perpendicular to the front wall and the rear wall of the housing.

16. The box opener assembly of claim 14, further comprising a slot extending through the peripheral wall of the housing wherein the blade moves through slot when the blade is moved between the stored position and the exposed position.

17. The box opener assembly of claim 16, the handle further comprising a top side and a bottom side, the slot being positioned proximate to the bottom side of the handle wherein the blade extends downwardly through the slot relative to the handle when the blade is moved into the exposed position.

18. The box opener assembly of claim 1, further comprising a slot extending through the housing, the slot having a width exceeding a width of the blade wherein the blade moves through slot when the blade is moved between the stored position and the exposed position.

19. A box opener assembly comprising:
a housing having an interior space, the housing having a front wall, a rear wall, and a peripheral wall being coupled to and extending between the front wall and the rear wall to define the interior space, the front wall and the rear wall being circular, the front wall having a diameter being equal to a diameter of the rear wall;
a blade being positioned within the interior space of the housing, the blade being rotatably coupled to the housing wherein rotation of the blade is configured to facilitate a user in cutting an object, the blade being movably coupled to the housing wherein the blade is selectively positionable in a stored position and an exposed position, the blade having a diameter being less than a diameter of the front wall of the housing wherein the blade is fully covered by the housing when the blade is in the stored position, the blade being exposed between the front wall and the rear wall of the housing when the blade is in the exposed position, the blade being circular;
an axle being coupled to the blade wherein the blade is rotatable about the axle, the axle extending between the front wall and the rear wall of the housing wherein the blade is rotatable along an axis being perpendicular to the front wall and the rear wall of the housing, the axle being movably positioned within the housing wherein movement of the axle moves the blade between the stored position and the exposed position;
a handle being coupled to the housing, the handle being elongated wherein the handle is configured to facilitate the user in manipulating the blade to cut the object while the blade is in the exposed position, the handle extending outwardly from the peripheral wall of the housing, the handle including a top side, a bottom side, and a lateral side being coupled to and extending between the top side and the bottom side, the lateral side having a forward surface, a rearward surface, and a terminal surface, the terminal surface being distally positioned on the handle relative to the housing;
a writing member being coupled to the terminal surface of the lateral side of the handle wherein the writing member is configured to facilitate the user in marking the object, the writing member being distally positioned on the handle relative to the housing, the writing member being selected from a group consisting of a marker, a highlighter, a pen, and a pencil;
an actuator movably coupling the blade to the housing, the actuator being coupled to the handle wherein the actuator is configured to be accessible to the user while the user is holding the handle whereby the actuator is configured to facilitate the user in moving the blade between the stored position and the exposed position while the user is holding the handle, the actuator being spaced from the writing member wherein the blade is configured to be in the stored position while the user is marking the object with the writing member to inhibit the blade from injuring the user and wherein the actuator is configured to inhibit the user from mistakenly marking the object with the writing member while the user is moving the blade between the stored position and the exposed position, the actuator including:
a panel movably coupling the axle to the handle wherein upward movement of the panel urges the blade into the stored position and wherein downward movement of the panel urges the blade into the exposed position, the panel having a housing end and a handle end, the housing end being positioned within the interior space of the housing, the axle extending through the panel proximate to the housing end, the handle end being positioned within the handle, the handle end being positioned proximate to the top side of the handle;
a tab being coupled to and extending upwardly from the panel wherein pressure on the tab moves the panel downwardly through the housing to urge the blade into the exposed position and wherein the panel moves upwardly through the housing to retract the blade into the stored position when pressure is removed from the tab, the tab having an upper surface being exposed above the top side of the handle, the upper surface being concavely arcuate wherein the upper surface is configured to facilitate the user in exerting pressure on the tab with a thumb of the user while the user is holding the handle with a hand on which the thumb is positioned, the tab being positioned adjacent to the handle while the blade is in the stored position, the tab being positioned adjacent to the housing while the blade is in the exposed position;
a plate being coupled to and extending downwardly from the top side of the handle toward the panel;
an arm being coupled to and extending upwardly from the panel toward the top side of the handle, the arm being positioned proximate to the handle end of the panel wherein the arm is spaced from the plate and wherein the plate is positioned between the arm and the tab, the arm being statically coupled to the panel;
a beam being coupled to the arm, the beam extending between the arm and the plate, the beam being statically coupled to the arm and movably coupled to the plate wherein downward movement of the panel slides the beam through the plate to move the arm toward the plate; and
a spring being coupled to the beam, the spring being compressed when the arm is moved toward the plate, the spring being biased to expand wherein the spring urges the arm away from the plate when pressure is removed from the tab whereby the spring urges the panel upwardly to move the blade into the stored position when pressure is removed from the tab;
a slot extending through the peripheral wall of the housing into the interior space, the slot having a width exceeding a width of the blade wherein the blade moves through slot when the blade is moved between the stored position and the exposed position, the slot being positioned proximate to the bottom side of the handle wherein the blade extends downwardly through the slot relative to the handle when the blade is moved into the exposed position, the axle being spaced from the slot by a first distance when the blade is in the stored position, the axle being spaced from the slot by a second distance when the blade is in the exposed position, the first distance exceeding the second distance;
a cap being removably couplable to the writing member wherein the cap fully covers the writing member while the cap is coupled to the writing member, the writing member being fully exposed when the cap is decoupled from the writing member;
a tether coupling the cap to the handle wherein the tether inhibits loss of the cap while the cap is decoupled from the housing, the tether extending from the terminal surface of the lateral side of the handle;
a well being fluidly coupled to the writing member wherein the well is configured to store a fluid being expelled by the writing member to mark the object, the well being positioned within the handle proximate to the terminal surface of the lateral side of the handle;
a light being coupled to the handle wherein the light is configured to be actuatable to facilitate visibility of the object, the light being positioned on the bottom side of the handle wherein the light is configured to face toward the object while the user is cutting the object with the blade;
a power source being electrically coupled to the light, the power source being positioned within the handle, the power source being a battery;
an access door being pivotably coupled to the handle wherein the access door is openable to expose the power source, the access door being positioned on the bottom side of the handle;
a control being electrically coupled to the power source wherein the control is actuatable to selectively actuate the light, the control being positioned on the forward surface of the lateral side of the handle wherein the control is configured to facilitate the user in actuating the light while the user is holding the handle, the control being positioned proximate to the housing; and
a clip being coupled to the handle wherein the clip is configured to releasably engage an item to facilitate the user in storing the handle on the item, the clip being positioned on the rearward surface of the lateral side of the handle, the clip being elongated, the clip being parallel to the handle.
